(19) United States
(12) Patent Application Publication
(10) Pub. No.: US 2011/0098875 A1
(43) Pub. Date: Apr. 28, 2011

(54) CONTROL APPARATUS AND COMPUTER PROGRAM

(75) Inventor: Yuri Kishita, Yokkaichi-shi (JP)

(73) Assignees: AUTONETWORKS TECHNOLOGIES, LTD., YOKKAICHI-SHI, MIE (JP); SUMITOMO WIRING SYSTEMS, LTD., YOKKAICHI-SHI, MIE (JP); SUMITOMO ELECTRIC INDUSTRIES, LTD., OSAKA-SHI, OSAKA (JP)

(21) Appl. No.: 12/994,988

(22) PCT Filed: Jul. 29, 2009
(86) PCT No.: PCT/JP2009/003582

§ 371 Date: Nov. 29, 2010

(30) Foreign Application Priority Data
Aug. 1, 2008 (JP) 2008-200072

(51) Int. Cl. G06F 7/00; G05B 15/00

(52) U.S. Cl. 701/29; 700/1; 701/1; 701/36

(57) ABSTRACT

Provided is a computer program and a control apparatus that can minimize a modification required for a part corresponding to scheduling of a program in response to a change of the program, even when the program is changed. A system monitoring program obtains operation conditions of each layer, to determine whether an operation mode should be changed or not, and selects an operation mode. A system configuration managing program notifies an operation mode to a configuration managing program of each layer. The configuration managing program determines an execution possibility of each program in accordance with the notified operation mode. A system scheduler performs scheduling of a scheduler included in each layer, in accordance with time passage and an event occurrence. The scheduler of each layer performs scheduling of programs allowed by the configuration managing program to be executed.

This application is the national phase under 35 U.S.C.§371 of PCT International Application No. PCT/JP2009/003582 which has an International filing date of Jul. 29, 2009 and designated the United States of America.

### BACKGROUND OF THE INVENTION

1. Field of the Invention

The present invention relates to a control apparatus and a computer program for controlling several devices, for example mounted on a vehicle, which can facilitate a labor, such as own development, expansion and modification.

2. Description of Related Art

A recent vehicle is provided with various electronic devices (on-vehicle devices). Thus, a recent vehicle is highly sophisticated. Higher sophistication of vehicle means to require higher numbers of on-vehicle devices. As it is known to utilize a control apparatus (e.g., ECU: electronic control unit) for controlling such higher numbers of on-vehicle devices, such higher sophistication causes enlarging and complicating the control apparatus. Therefore, the development of control apparatus becomes difficult, the development period of control apparatus becomes longer, the development cost of control apparatus becomes higher, and the like. As such the control apparatus includes a computer program to be executed for controlling the on-vehicle devices, such higher sophistication causes enlarging and complicating the computer program, too. Similarly, the development of computer program also becomes difficult, the development period of computer program also becomes longer, the development cost of computer program also becomes higher, and the like.

A control program of vehicle is proposed in a patent document 1 for reducing a burden on a developer of application program. This control program of vehicle is provided with: a platform program including a device driver for transferring data based on an input of hardware device to another processing; an application program that contributes to perform a processing in accordance with data obtained by a processing of platform program; and a connection processing part that intermediates data obtained by a processing of platform program to suit a processing of application program. The connection processing part intermediates between an interface of platform program and an interface of application program. A developer of application program can neglect the interface of platform program and thus it is expected to reduce the burden of developer.

A network system of vehicle is proposed in a patent document 2 for shortening a development period of complicated large system. This network system of vehicle is basically configured with a distributed control platform hierarchized into plural layers, and each layer works independently from the other layers. In other words, the network system of vehicle is an electronic control apparatus configured with: an application layer for providing an interface; a system infrastructure layer for performing a central control of resources; and a hardware abstraction layer for performing an abstraction of whole hardware system.

As described in the patent document 1 and the patent document 2, recent computer program for controlling on-vehicle devices is hierarchized in order to reduce the burden of developer. FIG. 8 is a schematic view showing a configuration example of conventional hierarchized computer program. The computer program illustrated in FIG. 8 is hierarchized into three layers: a platform layer 201, a middleware layer 202 and an application layer 203. The platform layer 201 includes plural programs (PF1, PF2 and PF3 in FIG. 8), and each of programs PFs 1-3 is for controlling an on-vehicle device, such as a sensor or an actuator mounted on a vehicle. Similarly, the application layer 203 includes plural programs (AP1, AP2 and AP3 in FIG. 8), and each of programs APs 1-3 is for actuating an on-vehicle device in accordance with a predetermined requirement specification and the like.

For example, a vehicle mounts a sensor, and data based on a detected value of sensor is generated by programs PFs 1-3 of platform layer 201. The generated data is transferred to the middleware layer 202. The middleware layer 202 converts the transferred data from the platform layer 201 in a data format suitable to the application layer 203, and transfers the converted data to the application layer 203. The programs APs 1-3 of application layer 203 contribute to perform processing based on the data transferred from the middleware layer 202, to obtain results of processing which include data for actuating an on-vehicle device, and to transfer the results of processing to the middleware layer 202. The middleware layer 202 converts the data transferred from the application layer 203 in a data format suitable to the platform layer 201, and transfers the converted data to the platform layer 201. The programs PFs 1-3 of platform layer 201 contribute to control an on-vehicle device, such as an actuator, in accordance with the data transferred from the middleware layer 202. Therefore, it is expected that the computer program illustrated in FIG. 8 can perform to control the on-vehicle device, e.g., so as to actuate the actuator in accordance with the detected value of sensor.

When a hardware configuration of on-vehicle device is changed and then the programs PFs 1-3 of platform layer 201 should be modified, it is basically required to modify only the middleware layer 202, but not the programs APs 1-3 of application layer 203, in such the computer program. In the case that the configuration of platform layer 201 varies in vehicle types, it is basically required only to provide another middleware layer 202 suitable to the application layer 203 and depending on each platform layer 201 for making the computer program function in various types of vehicles, but not to modify the programs APs 1-3 of application layer 203,

[Patent Document 1] Japanese Patent Application Laid-Open No. 2004-192541

[Patent Document 2] Japanese Patent Application Laid-Open No. 2006-142994

### SUMMARY OF THE INVENTION

However, the conventional computer program illustrated in FIG. 8 is hierarchized only for transferring and receiving data, but not for activating and scheduling programs in each layer. It is required to utilize some program in some layer for controlling all of the activation and the schedule. In addition, some program of some layer depends on another program of another layer, for example, because output data of programs PF 1 and PF 2 in platform layer 201 may be required for making the program AP1 of application layer 203 function. Hence, in the case that programs of each layer are changed, it is required to majorly modify such programs that contribute activating, scheduling and the like. Therefore, the development of computer program will become difficult.

In addition, as more on-vehicle devices are mounted, the computer program for controlling the mounted on-vehicle devices is required to be enlarged and complicated greater, and to include larger numbers of programs for each layer. Thus, the dependence of programs will be complicated greater. Therefore, the development of computer program will become much more difficult. These problems are not adequately solved even with the control program of vehicle proposed by the patent document 1 and even with the network system of vehicle proposed by the patent document 2.

The present invention is made in view of such circumstances, and has an object to provide a computer program, as well as a control apparatus including the computer program and controlling a device, which is configured with plural programs (or program fragments) and can minimize modifying or changing a part that is utilized as the activating and scheduling programs, even in the case that some part of program is modified or changed.

A control apparatus according to the present invention includes a plurality of executing means for executing one or more programs, performs data transmission between the executing means and controls a device, wherein each executing means comprises an execution schedule managing means for managing a schedule about execution of the one or more programs, and the control apparatus comprises an actuation instruction means for managing a schedule about actuation of each execution schedule managing means and for transferring an actuation instruction to each execution schedule managing means.

Additionally, a control apparatus according to the present invention includes a plurality of executing means for executing one or more programs and performs data transmission between the executing means, wherein each execution means comprises an execution possibility determining means for determining whether the one or more programs should be executed or not, and the control apparatus comprises an actuation condition determining means for determining an operation condition utilized for the determination performed by the execution possibility determining means and for transferring the determined operation condition to each execution possibility determining means.

Additionally, a control apparatus according to the present invention includes a plurality of executing means for executing one or more programs and performs data transmission between the executing means, wherein each executing means comprises: an execution possibility determining means for determining whether the one or more programs should be executed or not; and an execution schedule managing means for managing a schedule about execution of the one or more programs, and the control apparatus comprises: an actuation condition determining means for determining an operation condition utilized for the determination performed by the execution possibility determining means and for transferring the determined operation condition to each execution possibility determining means; and an actuation instructing means for managing an schedule about an actuation of the execution schedule managing means and for transferring an actuation instruction to each execution schedule managing means

Additionally, a control apparatus according to the present invention includes the program executed by each executing means that gives a notification to the execution schedule managing means when the program executed by each executing means requires executing another program, when notified, the execution schedule managing means notifies the notification to the actuation instruction means, and the actuation instruction means manages a schedule about an operation of execution schedule managing means in accordance with time passage and the notification.

Additionally, a control apparatus according to the present invention includes the actuation condition determining means that comprises: an operation condition obtaining means for obtaining an operation condition of each executing means; and a judging means for judging in accordance with the obtained operation condition whether or not the actuation condition of device should be changed or not, and when it is judged that the actuation condition of device should be changed, an operation condition is determined and then the determined operation condition is transferred to each execution possibility determining means.

Additionally, a control apparatus according to the present invention includes the actuation condition determining means that comprises an initializing means for initializing the executing means in accordance with the determined operation condition, when it is determined that the actuation condition of device should be changed.

Additionally, a computer program according to the present invention includes a plurality of program groups, each of which includes one or more program fragments, and makes a computer control a device through data transmission performed between program groups, wherein each program group comprises an execution schedule managing program fragment for making the computer manage a schedule about execution of one or more program fragments included in the program group, and the computer program comprises a control program for making the computer execute steps of: managing a schedule about execution of the execution schedule managing program fragment included in each of the program groups; and transferring an operation instruction to the execution schedule managing program of each program group.

Additionally, a computer program according to the present invention includes a plurality of program groups, each of which includes one or more program fragments, and makes a computer control a device through data transmission performed between program groups, wherein each program group comprises an execution possibility determining program fragment for making the computer determine whether the one or more program fragments should be executed or not, and the computer program comprises a control program for making the computer execute steps of: determining an operation condition utilized for the determination performed by the execution possibility determining program fragment; and transferring the determined operation condition to the execution possibility determining program fragment of each program group.

Additionally, a computer program according to the present invention includes a plurality of program groups, each of which includes one or more program fragments, and makes a computer control a device through data transmission performed between program groups, wherein each program group comprises: an execution possibility determining program fragment for making the computer determine whether the one or more program fragments included in the program group should be executed or not; and an execution schedule managing program fragment for making the computer manage a schedule about execution of the one or more program fragments included in the program group, in accordance with the determination performed by the execution possibility determining program fragment, and the computer program comprises a control program for making the computer execute steps of: determining an operation condition utilized for the determination performed by the execution possibility determining program fragment; transferring the determined operation condition to the execution possibility determining program fragment of each program group; managing a schedule about execution of the execution schedule managing program fragment included in each program group; and transferring an operation instruction to the execution schedule managing program fragment of each program group.

According to the present invention, a computer program is configured with plural program groups, for example, a platform layer, an middleware layer and an application layer, each of which includes one or more programs or program fragments (hereinafter, simply refer to “programs”), and this computer program is executed by a control apparatus, such as an ECU. Therefore, even when one program group requires to be modified or improved, it is possible to minimize the effect caused by this requirement on another program group, to facilitate developing the computer program and to facilitate developing the control apparatus.

Each program group (executing means) is configured to include an execution schedule managing program fragment (execution schedule managing program fragment, and execution schedule managing means) for performing scheduling about execution of one or more programs included in this program group. Furthermore, the computer program is configured to include a control program (actuation instructing means) for managing a schedule about activation of execution schedule managing program included in each program group, and for transferring an operation instruction based on the schedule to each execution schedule managing program.

Thus, the program for performing scheduling about programs included in each program group is different from the program for performing scheduling about respective program groups. Hence, it is possible to hierarchize the scheduling part of the computer program. Therefore, when it is required to modify or improve one program group, it is enough to modify or improve the execution schedule managing program of said one program group, but not required to perform such modification or improvement for another program group.

According to the present invention, each program group includes the execution possibility determining program (execution possibility determining program fragment, execution possibility determining means) for determining whether one or more programs included in the program group should be executed or not. In addition, the computer program includes the control program (actuation condition determining means) for determining an actuation condition utilized for the determination of execution possibility performed by the execution possibility determining program of each program group and for transferring the determined actuation condition to each execution possibility determining program.

Thus, the actuation condition determined by the control program restricts the program to be executed by each program group. Hence, it is possible to simplify the complicated dependence between plural programs. Therefore, it is possible to facilitate scheduling plural programs. In addition, the execution possibility of program is determined in accordance with the actuation condition from the control program by the execution possibility determining program of each program group. When it is required to modify or improve one program group, it is enough to modify or improve the execution possibility determining program of said one program group, but not required to perform such modification or improvement for another program group.

Anyway, each program group receives input data from another program group and transfers output data to another program group. When the change occurs in the input data or in the output data, a so-called event happens to occur and thus it is required to activate a program in accordance to the occurred event. Therefore, when the change occurs in the input data or the output data and then the event occurs, the programs included in each program group according to the present invention notifies about the event occurrence to the execution schedule managing program. The execution schedule managing program notifies about the event occurrence further to the control program. The control program can perform scheduling about execution of each program.

Actuations of on-vehicle device are changed in accordance with the case, for example, whether the vehicle is driven or not, the engine is turned on or not, the ignition switch is turned off or not, and the like. Thus, it is also required to change even the number and the type of programs to be executed by the control apparatus. The control program according to the present invention obtains the operation condition of each program group, to make each program group monitor the actuation condition of device, such as the engine or the ignition switch. Therefore, the control program can determine whether an actuation condition of objective device to be controlled should be changed or not, in accordance with detection results of stopped engine or turned off ignition switch.

When having determined that current actuation condition should be changed, the control program determines a suitable actuation condition that should be changed with the current actuation condition, and transfers the determined actuation condition to the execution possibility determining program of each program group. Thus, each program group changes the program to be executed. Therefore, it is possible to change the actuation condition of objective device to be controlled.

In addition, the control program may be configured to further contribute in performing initialization processing of each group at that time (for example, releasing resources, such as memory, utilized by the program whose execution should be terminated, providing resources utilized by the program whose execution should be started, and the like). Thus, the control program can perform processing that should be performed commonly by respective program groups. Therefore, it is possible to reduce the burden on each program group.

According to the present invention, each program group includes the execution schedule managing program for managing the schedule about execution processing of program, and the computer program includes plural program groups and further includes the control program for managing a schedule about execution of execution schedule managing program included in each program group and for transferring an operation instruction based on the schedule to each execution schedule managing program. Thus, the program for scheduling about programs included in each program group is different from the program for performing the scheduling about program groups. Therefore, it is possible to hierarchize the computer program not only for the part regarding data transmission but also for the part regarding scheduling about programs.

In addition, each program group includes the execution possibility determining program for determining the execution possibility of programs, and the computer program includes the control program for determining the actuation condition utilized for the determination of execution possibility and for transferring the determined actuation condition to each execution possibility determining program. Thus, the executions of plural programs are restricted, the complicated dependence between programs can be simplified and the computer program can be hierarchized for the part regarding control of execution possibility.

Hence, even when it is required to modify or improve one program group, it is not required to perform such modification or improvement for another program group. Therefore, it is possible to facilitate developing, modifying and improving the computer program, and to improve the reusability, the replaceability, the applicability and the like of programs included in each program layer.

The above and further objects and features of the invention will more fully be apparent from the following detailed description with accompanying drawings.

### BRIEF DESCRIPTION OF THE DRAWINGS

FIG. 1 is a block diagram showing a configuration of control apparatus according to the present invention.

FIG. 2 is a schematic view showing a software configuration of on-vehicle device control program according to the present invention.

FIG. 3 is a schematic view showing examples of programs in an application layer.

FIG. 4 is a schematic view for explaining a determination processing on execution possibility of program performed by a configuration managing program.

FIG. 5 is a flowchart showing a procedure performed by a system manager layer.

FIG. 6 is a flowchart showing the procedure performed by the system manager layer.

FIG. 7 is a flowchart showing a procedure performed by each of layers, i.e., a platform layer, an middleware layer and the application layer.

FIG. 8 is a schematic view showing an example configuration of conventional hierarchized computer program.

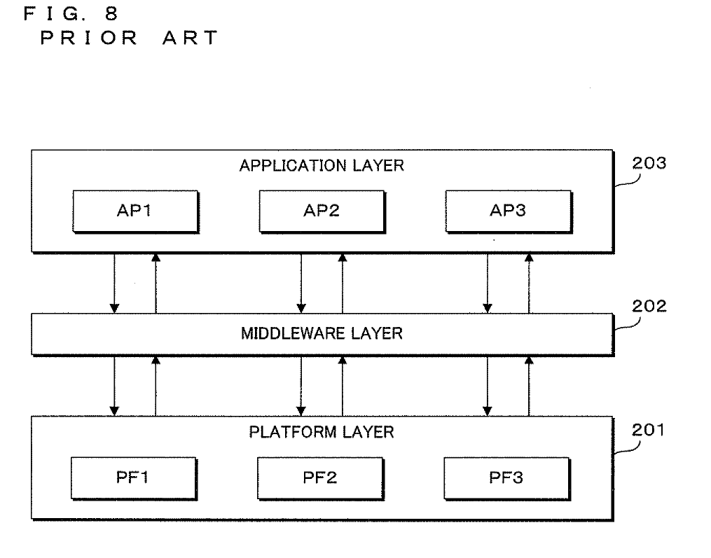

### DESCRIPTION OF THE PREFERRED EMBODIMENTS

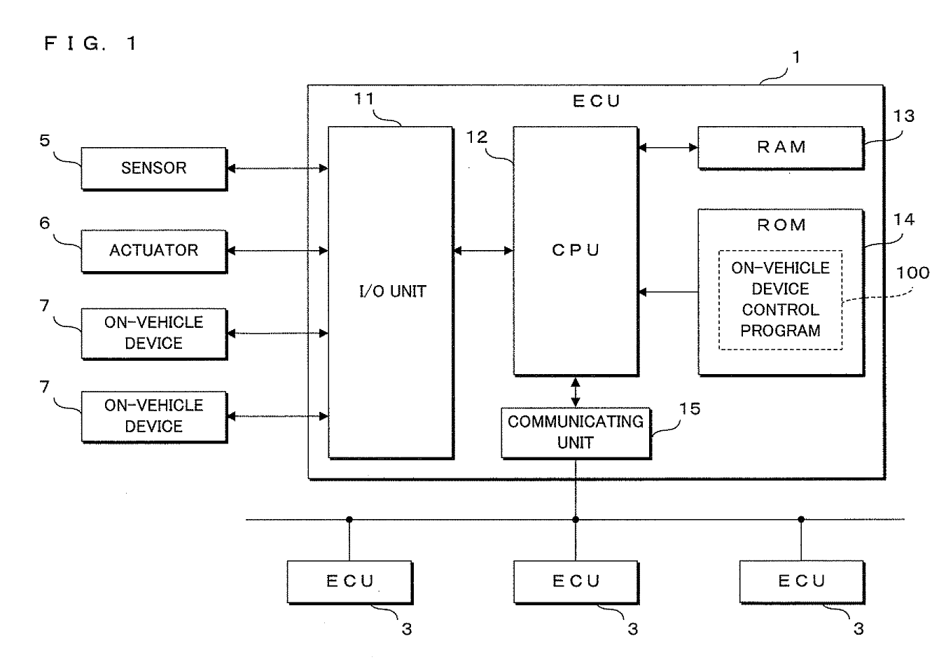

Hereinafter, an embodiment of the present invention is described in detail with reference to figures. FIG. 1 is a block diagram showing a configuration of control apparatus according to the present invention. An item number “1” in FIG. 1 is an ECU that controls several devices mounted on a car, i.e., a sensor 5, an actuator 6 and another on-vehicle device 7, and corresponds to the control apparatus according to the present invention. The ECU 1 includes an input-output interfacing unit (I/O unit) 11 that is connected to the sensor 5, the actuator 6 and another on-vehicle device 7 thorough a cable. The I/O unit 11 performs data transmission with the sensor 5, the actuator 6 and another on-vehicle device 7, to obtain several detection results from the sensor 5, to transfer actuation instructions to the actuator 6, and to receive/transfer data from/to the on-vehicle device 7.

The ECU 1 further includes a central processing unit (CPU) 12 that performs several calculation processing, control processing for each unit in the ECU 1 and the like. The I/O unit 11 transfers the detection results from the sensor 5, the data from another on-vehicle device 7 and the like, to the CPU 12. Vice versa, the I/O unit 11 transfers the data from the CPU 12 to the actuator 6 and to another on-vehicle device 7. The CPU 12 reads out and then executes an on-vehicle device control program (computer program) 100 previously stored in a read only memory (ROM) 14, performs the calculation processing, the control processing and the like, and then proceeds the procedure with storing temporal data generated by these processing into a random access memory (RAM) 13.

The ROM 14 is e.g., a mask ROM, an electrically erasable programmable ROM (EEPROM) or the like, and is configured with non-volatile memory elements. The ROM 14 is prepared to previously store the on-vehicle device control program 100, data (not shown) required for executing the on-vehicle device control program 100 and the like. The RAM 13 is, e.g., a static RAM (SRAM), a dynamic RAM (DRAM) or the like, and is configured with such memory elements.

As the car is provided with other plural ECUs 3, 3, . . . , the ECU 1 is connected to these ECUs 3, 3, . . . through a network, such as a controller area network (CAN). The ECU 1 includes a communicating unit 15 that performs data transmission with these ECUs 3, 3, . . . through the network. The ECU 1 utilizes the communicating unit 15 for performing the data transmission with these ECUs 3, 3, . . . . Thus, the ECU 1 can obtain data even from on-vehicle devices that are connected to these ECUs 3, 3, . . . but not directly connected to the ECU 1. Furthermore, the ECU 1 can control the on-vehicle devices connected to these ECUs 3, 3, . . . .

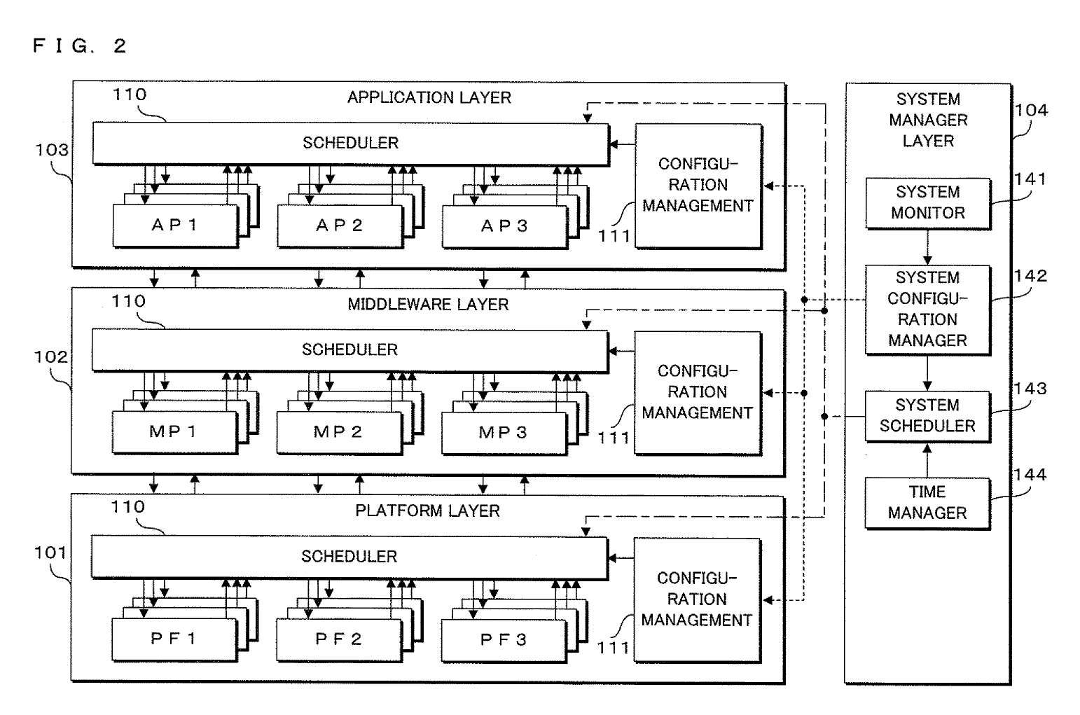

FIG. 2 is a schematic view showing a software configuration of on-vehicle device control program 100 according to the present invention. The on-vehicle device control program 100 is a computer program hierarchized into three layers, i.e., a platform layer 101, an middleware layer 102 and an application layer 103. The platform layer 101 includes plural programs PF1, PF2, . . . that consist of: a program for controlling the sensor 5 connected to the I/O unit 11 of ECU 1; a program for controlling the actuator 6 connected to the I/O unit 11 of ECU 1; a program for controlling another on-vehicle device 7 connected to the I/O unit 11 of ECU 1; a program for making the communicating unit 15 perform the data transmission with these ECUs 3, 3, . . . based on the CAN, and the like. The platform layer 101 includes plural programs PF1, PF2, . . . that consist of another program for controlling the sensor 5 connected to the I/O unit 11 of ECU 1; another program for controlling the actuator 6 connected to the I/O unit 11 of ECU 1; another program for controlling another on-vehicle device 7 connected to the I/O unit 11 of ECU 1; another program for making the communicating unit 15 perform the data transmission with these ECUs 3, 3, . . . based on the CAN, and the like. The programs PF1, PF2, . . . contribute to transfer data obtained from the sensor 5 to the middleware layer 102, data obtained from another on-vehicle device 7 to the middleware layer 102, and the like. Furthermore, the programs PF1, PF2, . . . contribute to control the actuator 6 in accordance with the actuation instruction transferred from the middleware layer 102, another on-vehicle device 7 in accordance with the actuation instruction transferred from the middleware layer 102, and the like.

The middleware layer 102 is functionally positioned between the platform layer 101 and the application layer 103, converts a format of data transferred from the platform layer 101 to be suitable to the application layer 103, and then transfers the converted data to the application layer 103. Furthermore, the middleware layer 102 converts a format of data transferred from the application layer 103 to be suitable to the platform layer 101, and then transfers the converted data to the platform layer 101. The middleware layer 102 includes plural programs (represented by MP1, MP2, . . . in FIG. 2) which contribute to convert the format of data as described above.

The application layer 103 includes plural programs AP1, AP2, . . . that contribute to determine an actuation of actuator 6, an actuation of another on-vehicle device 7 and the like, in accordance with data transferred through the platform layer 101 and the middleware layer 102 from the sensor 5, from another on-vehicle device 7 and the like, in accordance with predetermined requirement specifications and the like. The programs AP1, AP2, . . . contribute to transfer output data to the middleware layer 102, as the output data are an actuation instruction for the actuator 6, an actuation instruction for another on-vehicle device 7 and the like.

In other words, the programs PF1, PF2, . . . included in the platform layer 101 of on-vehicle device control program 100 contribute to generate data based on the output of sensor 5, on-vehicle device 7 and the like mounted on the car, and the generated data are transferred to the middleware layer 102. The programs MP1, MP2, . . . of middleware layer 102 contribute to convert the data transferred from the platform layer 101 to be suitable to the application layer 103, and contribute to transfer the converted data to the application layer 103. The programs AP1, AP2, . . . of application layer 103 contribute to perform several calculation processing based on the data transferred from the middleware layer 102, and then contribute to determine the actuation of actuator 6, the actuation of on-vehicle device 7 and the like.

The programs AP1, AP2, . . . of application layer 103 contribute to transfer output data to the middleware layer 102, as the output data represent actuation instructions for actuating the actuator 6, the on-vehicle device 7 and the like. The programs MP1, MP2, . . . of middleware layer 102 contribute to convert data transferred from the application layer 103 to be suitable to the platform layer 101, and then contribute to transfer the converted data to the platform layer 101. The programs PF1, PF2, . . . of platform layer 101 contribute to control the actuator 6, the on-vehicle device 7 and the like, in accordance with the data transferred from the middleware layer 102.

As described above, data obtained from the sensor 5, the on-vehicle device 7 and the like are transferred between the three layers in the on-vehicle device control program 100, and are processed at each layer, in order to control the actuator 6, the on-vehicle device 7 and the like. A program developer for each layer requires knowing just the contents of data transferred between respective layers, but not the data processing performed at the other layers. Furthermore, it is possible to properly categorize plural programs included in each layer, in accordance with the types of device to be controlled, the types of processing to be performed, the types of data to be processed and the like. Moreover, a program of each layer can contribute to perform processing through the data transmission with another program of the same layer.

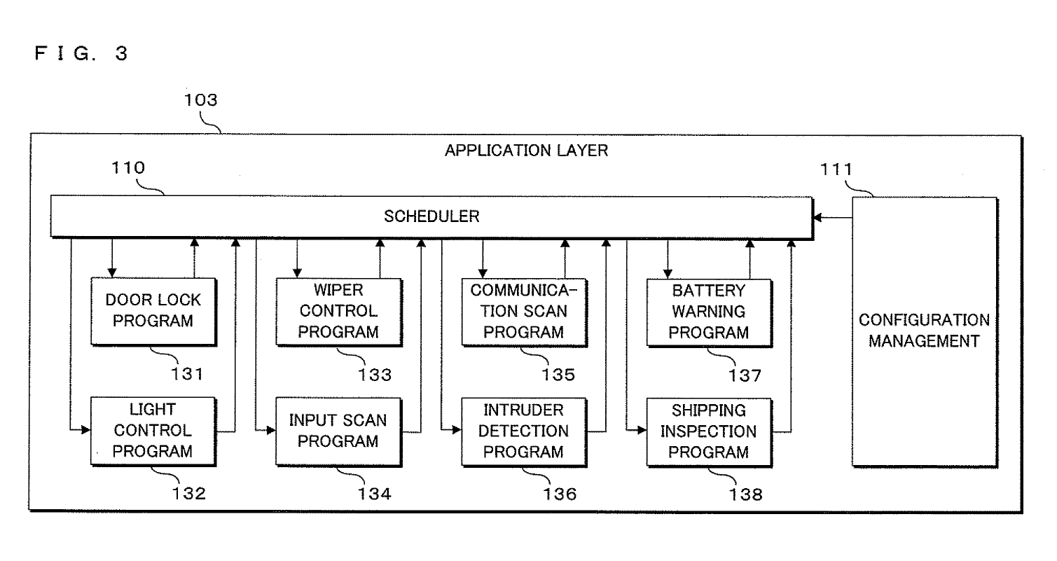

FIG. 3 is a schematic view showing examples of programs AP1, AP2, . . . included in the application layer 103. The application layer 103 includes several programs (corresponding to the programs AP1, AP2, . . . shown in FIG. 2), such as a door lock program 131, a light control program 132, a wiper control program 133, an input scan program 134, a communication scan program 135, an intruder detection program 136, a battery warning program 137, and a shipping inspection program 138. In this embodiment, the programs AP1, AP2, . . . of application layer 103 are categorized, in accordance with the types of on-vehicle device to be controlled and with the types of function implemented by respective programs.

The door lock program 131 is for locking/unlocking a door of car in response to user's handling on a switch mounted on the door, in response to user's handling on a remote controller or the like. A light control program 132 is for turning on/off a headlight of car in response to user's handling on a headlight switch mounted near the driver seat of car, in accordance with brightness detected by a light sensor or the like. The wiper control program 133 is for actuating a wiper of car in response to user's handling on a wiper switch mounted near the driver seat of car, in accordance with rain drop detected by a rain sensor or the like.

The input scan program 134 is for detecting user's handling on switches, a touch screen or the like mounted on an instrument panel of car, for recognizing an actuation condition based on the user's handling and the like. The communication scan program 135 is for determining whether data is received from another ECU 3 by the communicating unit 15 or not, and for notifying, in the case of determining that such data is received, of the received data to another program that requires this received data.

The intruder detection program 136 is for detecting the presence of intruder in the car, in accordance with a detection result of sensor 5 (e.g., vibration sensor) among several sensors mounted on the car. The battery warning program 137 is for detecting a remaining capacity of battery mounted on the car in accordance with data of sensor 5 (e.g., current/voltage sensor), and for warning about the reduction of remaining capacity. The shipping inspection program 138 is for automatically inspecting at the last step of manufacturing the car (i.e., at the factory shipping) whether on-vehicle devices work correctly on the car or not.

The on-vehicle control program 100 includes many programs, as a whole, because each of three layers includes plural programs. However, the ECU 1 can execute only one program at a time, because the number of CPU 12 mounted on the ECU is just one. Thus, it is required to select one program to be executed by the CPU 12 among the many programs included in the on-vehicle device control program 100 and then to change the current program with the selected program (so-called scheduling processing).

The on-vehicle device control program 100 according to the present invention includes a scheduler program (hereinafter, refer to a scheduler) 110 and a configuration managing program (simply represented by a “configuration management” in FIG. 2) 111 in each of three layers, the platform layer 101, the middleware layer 102 and the application layer 103. In addition, the on-vehicle device control program 100 includes a system manager layer 104 that controls the scheduler 110 and the configuration managing program 111 in each layer.

Some program in some layer contributes to perform processing based on data transferred from another program in the same layer or from another layer. When the so-called event occurs for some program that requires activating another program due to the change of input/output data, said some program contributes to notify the event occurrence to a scheduler 110 in the same layer.

The scheduler 110 of each layer includes a timer (or may obtain time information from a timer functionally positioned somewhere in the on-vehicle device control program 100), changes current program with another program among plural programs of the same layer in a predetermined interval, and executes said another program. Furthermore, the scheduler 110 of each layer performs the change/execution processing, when the event occurrence was notified from another program of the same layer as described above, too. The scheduler 110 selects one program to be executed among plural programs for every predetermined time period and for every notification of event occurrence. Although the scheduler 110 executes the selected program, the execution order of plural programs may be determined by a conventional scheduling method, such as a first in first out (FIFO) method and a method considering a priority. In addition, when such event occurrence is notified to the scheduler 110 from another program, the scheduler 110 notifies the event occurrence to a system scheduler 143 (described later) included in the system manager layer 104,

Anyway, the car is provided with many on-vehicle devices, and the on-vehicle device control program 100 includes many programs for each of layers, i.e., the platform layer 101, the middleware layer 102 and the application layer 103. However, for example, it is required for a moving car neither to actuate an on-vehicle device regarding to car security, nor to execute a program for controlling the on-vehicle device regarding to car security. Therefore, in the on-vehicle device control program 100 according to the present invention, the configuration managing program 111 of each layer contributes to determine whether a program should be executed or not, and to notify the determination result to the scheduler 110 of the same layer, and then the scheduler 110 contributes to execute only the program determined by the configuration managing program 111 to be executed. In other words, the program configuration of each layer is determined by the configuration managing program 111 of each layer, and the scheduling processing is performed by the scheduler 110 of each layer in accordance with the determined program configuration of each layer.

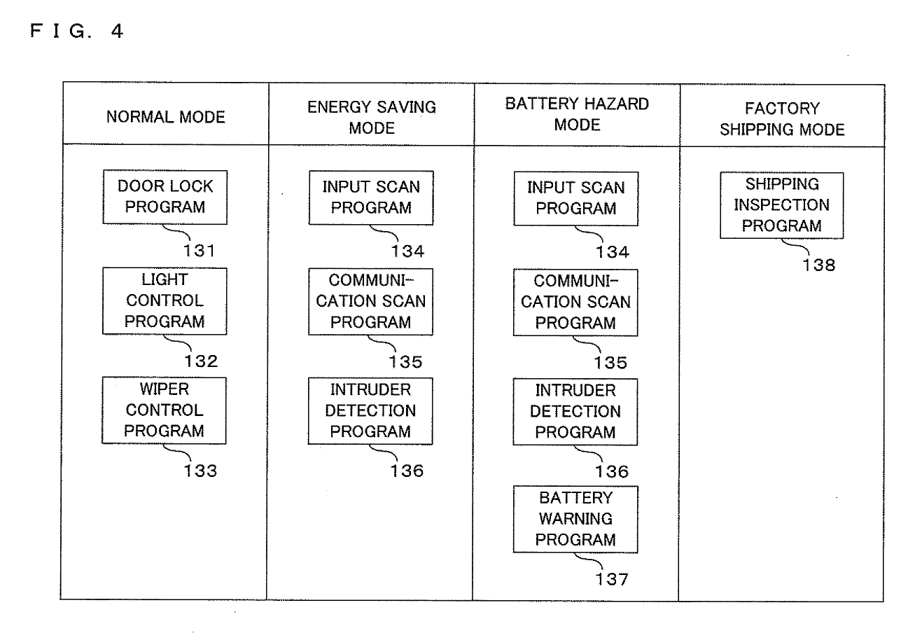

FIG. 4 is a schematic view for explaining a determination processing on execution possibility of program performed by the configuration managing program 111, in the case that the configuration managing program 111 is included in the application layer 103 illustrated in FIG. 3. For example, the ECU 1 (and the on-vehicle device control program 100) performs processing in any mode among several modes: a normal mode after which an engine of car is turned on; an energy saving mode during which the engine stops; a battery hazard mode for which additional function is provided with the energy saving mode to check the remaining capacity of battery; and a factory shipping mode for performing a shipping inspection at the time of shipping a car.

In the normal mode, the configuration managing program 111 of application layer 103 allows executing the door lock program 131, the light control program 132 and the wiper control program 133, but prohibits executing the other programs. Therefore, the scheduling processing is performed in the normal mode with only these three programs by the scheduler 110 of application layer 103.

In the energy saving mode, the configuration managing program 111 of application layer 103 similarly allows executing only the input scan program 134, the communication scan program 135 and the intruder detection program 136. In the battery hazard mode, the configuration managing program 111 of application layer 103 similarly allows executing only the battery warning program 137 plus the programs allowed in the energy saving mode. In the factory shipping mode, the configuration managing program 111 of application layer 103 similarly allows executing only the shipping inspection program 138.

In the case that each program of application layer 103 is configured to be the so-called object and the scheduler 110 can generate and delete such the object corresponding to each program, it may be configured to generate the object corresponding to the program allowed by the configuration managing program 111 and to delete the object corresponding to the program prohibited by the configuration managing program 111. Alternatively, the configuration managing program 111 may contribute to generate and delete such the object, and the scheduler 110 may contribute to perform the scheduling processing about the object generated by the configuration managing program 111. In these cases, the program configuration of application layer 103 is changed in accordance with the determination of configuration managing program 111.

The scheduler 110 and the configuration managing program 111 of each layer are controlled by the system manager layer 104. The system manager layer 104 works independently from the platform layer 101, the middleware layer 102 and the application layer in the on-vehicle device control program 100, and transfers operation instructions to the scheduler 110 and the configuration managing program 111 of each layer. The system manager layer 104 includes several programs, such as a system monitoring program (simply represented by “system monitor” in FIG. 2) 141, a system configuration managing program (simply represented by “system configuration manager” in FIG. 2) 142, a system scheduler 143 and a time managing program (simply represented by “time manager” in FIG. 2) 144.

The system monitoring program 141 contributes to obtain operation conditions of platform layer 101, middleware layer 102 and/or application layer 103, and to monitor the change in these operation conditions, for determining whether or not current operation mode should be changed with another among the operation modes illustrated in FIG. 4 (i.e., the normal mode, the energy saving mode, the battery hazard mode and the factory shipping mode). For example, when contributing to monitor the change in operation condition of program regarding to data about an ignition switch of car, the system monitoring program 141 can contribute to determine whether the engine of car is turned on or not and further determine whether the engine should be actuated in the normal mode or in the energy saving mode.

For example, when further contributing to monitor the change in operation condition of program regarding a switch mounted on the instrument panel of car, the system monitoring program 141 can contribute to determine whether a function is activated for warning about the reduction of remaining capacity or not, and further determine whether the engine should be actuated in the battery hazard mode or not. For example, when alternatively contributing to monitor the change in operation condition of program regarding the communicating unit 15 of ECU 1, the system monitoring program 141 can contribute to determine whether or not the network of car is connected to an inspection apparatus utilized at the shipping time, and further determine whether the engine should be actuated in the factory shipping mode or not.

When it has been determined in accordance with the operation conditions of programs included in respective layers that the current mode should be changed, the system monitoring program 141 contributes to select one mode among four modes described above in accordance with the obtained operation conditions.

The system configuration managing program 142 contributes to notify about the mode selected by the system monitoring program 141 toward the configuration managing program 111 of each layer, and to instruct the configuration managing program 111 of each layer to perform change processing for changing the current mode. The change processing for changing the current mode includes: processes for terminating an executed program (hereinafter, refer to “post-processing”), such as releasing resources utilized for the current program executed before the change processing; processes for performing initialization in order to start executing a program (hereinafter, refer to “pre-processing”), such as providing/setting resources utilized for a program executed after the change processing; and the like.

The system configuration managing program 142 contributes to instruct the configuration managing program 111 of each layer to perform the post-processing, the pre-processing and the like. Furthermore, the system configuration managing program 142 contributes to perform such post-processing, pre-processing and the like that should be performed due to the change processing by whole of the system. In the case that the system configuration managing program 142, as well as the configuration managing program 111 of each layer, is configured to lead the post-processing, the pre-processing and the like that are required for the change processing, a program developer of each layer can define the post-processing, the pre-processing and the like of own layer, without knowing the program configuration of another layer. Therefore, it is possible to facilitate developing the on-vehicle device control program 100.

When having been notified about the selected mode from the system configuration managing program 142 of system manager layer 104, the configuration managing program 111 of each layer contributes to determine in accordance with the notified selected mode whether each program of own layer should be executed or not, and to transfer the determination results to the scheduler 110 of own layer. Furthermore, the configuration managing program 111 of each layer is instructed to perform the post-processing, the pre-processing and the like, from the system configuration managing program 142 of system manager layer 104, and then contributes to perform the post-processing, the pre-processing and the like suitable to the determined programs to be executed, in response to the instruction from the system configuration managing program 142. Therefore, each layer can execute a proper program of own layer in accordance with the mode selected by the system manager layer 104.

The system scheduler 143 contributes to select one layer among three layers, i.e., the platform layer 101, the middleware layer 102 and the application layer 103 in the on-vehicle device control program 100, and to transfer an operation instruction to the scheduler 110 of selected layer, in order to execute a program included in the selected layer, In other words, the system scheduler 143 contributes to perform the scheduling processing about these three layers. When having been notified about the event occurrence from the scheduler 110 of any layer or when having been notified about the passage of predetermined time from the time managing program 144, the system scheduler 143 contributes to change the layer to be activated.

The time managing program 144 is for managing the interval to change the activated layer. Every time when a predetermined time has passed, the time managing program 144 notifies about the passage of predetermined time to the system scheduler 143.

In the on-vehicle device control program 100 according to the present invention, the system scheduler 143 of system manager layer 104 contributes to perform the scheduling processing of the three layers, i.e., the platform layer 101, the middleware layer 102 and the application layer 103, and the scheduler 110 of each layer contributes to perform the scheduling processing of programs included in own layer, in order to select a proper program to be executed. Therefore, it is possible to functionally separate the scheduling processing about programs for a layer from another scheduling processing about programs for another layer. It may be configured to utilize the same scheduling method for the scheduler 100 of every layer, or utilize various scheduling methods for the schedulers 100, 100, . . . .

The on-vehicle device control program 100 is configured with plural layers, each of which performs to change the program to be executed in own layer, since the system monitoring program 141 of system manager layer 104 monitors operation conditions of programs included in each layer, the system configuration managing program 142 selects the mode based on the monitored operation conditions, and the configuration managing program 111 of each layer is notified about the selected mode. Therefore, it is possible to prevent each layer from activating unnecessary programs, and to reduce the burden of scheduling processing on the scheduler 110 of each layer.

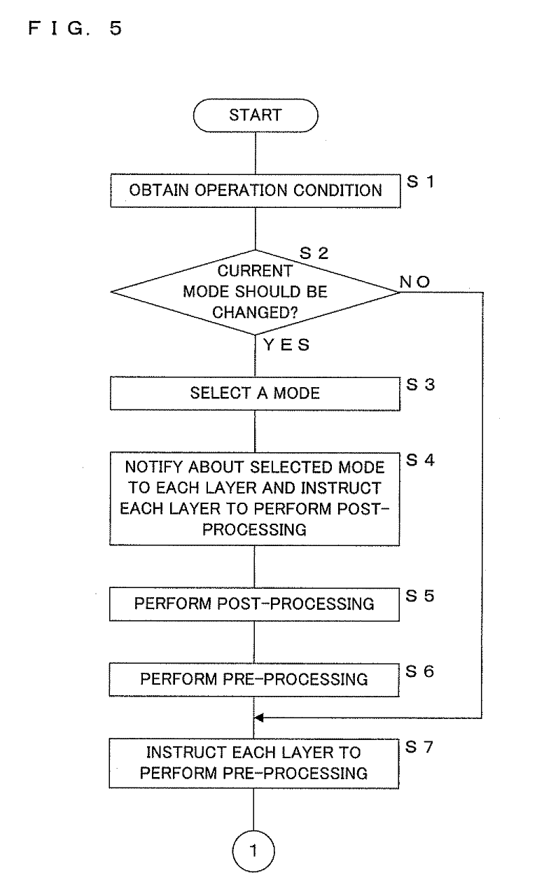

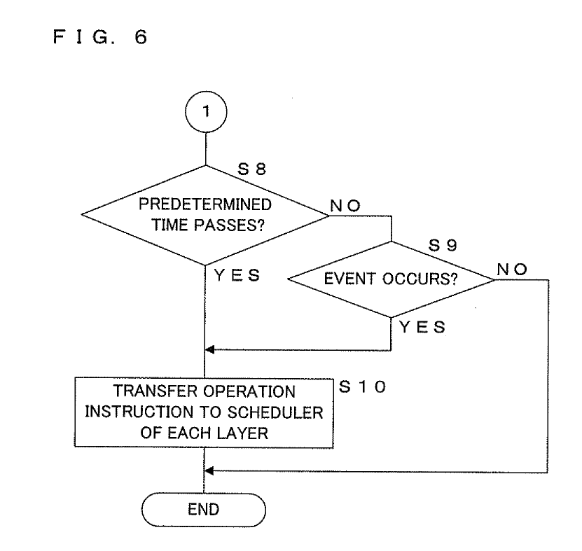

Next, it will be described in reference with flowcharts about operations of on-vehicle device control program 100 according to the present invention. FIG. 5 and FIG. 6 are flowcharts showing a procedure performed by the system manager layer 104. At first, the system manager layer 104 executes the system monitoring program 141, obtains operation conditions of platform layer 101, middleware layer 102 and application layer 103 (step S1), and determines in accordance with the obtained operation conditions whether the current mode should be changed or not (step S2). When having determined that the current mode should not be changed (S2: NO), the system manager layer 104 proceeds the procedure to the step S8, without performing processing of following steps S3-S8. When having determined that the current mode should be changed (S2: YES), the system manager layer 104 utilizes the system monitoring program 141 for selecting the next mode (step S3).

Then, the system manager layer 104 executes the system configuration managing program 142, notifies about the mode selected by the system monitoring program 141 toward the configuration managing program 111 of each layer, and instructs the configuration managing program 111 of each layer to perform the post-processing for terminating the program executed before the change processing (step S4). Then, the system manager layer 104 utilizes the system configuration managing program 142 for performing the post-processing and the pre-processing required for the whole of system due to the change processing (steps S5 and S6), instructs the configuration managing program 111 of each layer to further perform the pre-processing in order to start executing the program that should be executed after the change processing (step S7), and proceeds the procedure to the step S8.

Then, the system manager layer 104 executes the system scheduler 143, and determines whether the passage of predetermined time is notified from the time managing program 144 or not (step S8). When having determined that the passage of predetermined time is not notified (S8: NO), the system manager layer 104 determines whether or not the event occurrence is notified from the scheduler 110 of any layer or not (step S9).

When having determined that the passage of predetermined time is notified (S8: YES), or when having determined that the event occurrence is notified (S9: YES), the system manager layer 104 utilizes the system scheduler 143 for performing the scheduling processing based on a predetermined algorism, transfers the operation instruction to the scheduler 110 of any layer to be activated (step 510), and terminates the procedure. When having determined that the passage of predetermined time is not notified and that the event occurrence is not notified (S9: NO), the system manager layer 104 utilizes the system scheduler 143 for terminating the procedure.

The system manager layer 104 repeats the procedure from the step S1 to the step S10 described above. Therefore, it is possible to continuously perform the monitoring processing of operation conditions, the determining processing of mode change, the scheduling processing of scheduler 110 included in each layer, and the like.

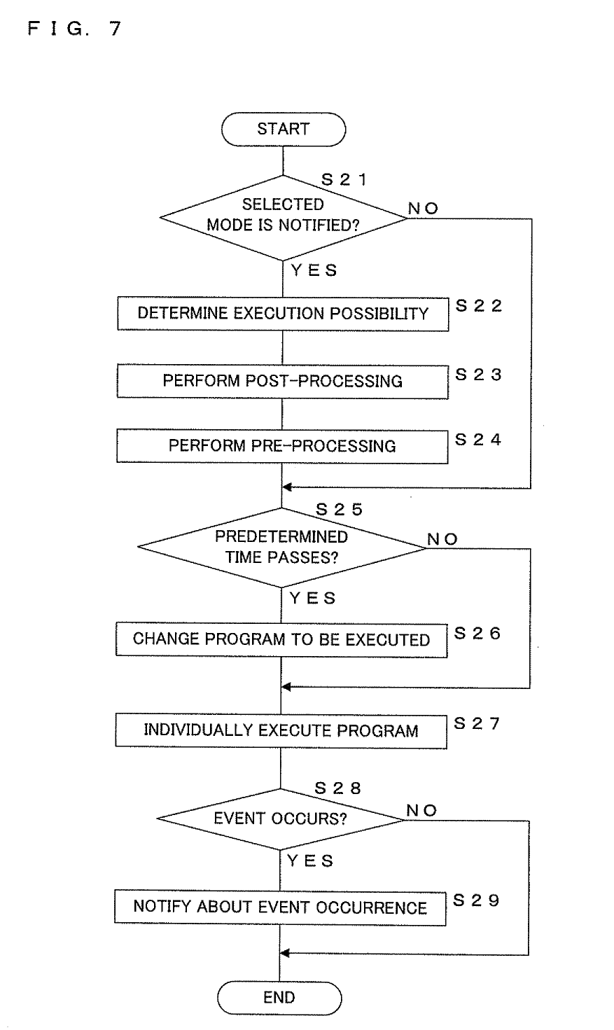

FIG. 7 is a flowchart showing a procedure performed by each of layers, i.e., the platform layer 101, the middleware layer 102 and the application layer 103. Each of layers (i.e., the platform layer 101, the middleware 102 and the application layer 103) utilizes the configuration managing program 111 of own layer, and determines whether the selected mode is notified (see the step S4 illustrated in FIG. 5) from the system configuration managing program 142 of system manager layer 104 or not (step S21). When having determined that the selected mode is not notified (S21: NO), each of layers proceeds the procedure to step S25, without performing processing of steps S22-S24.

When having determined that the selected mode is notified (S21: YES), each of layers utilizes the configuration managing program 111 of own layer, and determines in accordance with the notified selected mode whether each program of own layer should be executed or not (step S22). The configuration managing program 111 of each layer contributes to perform the post-processing of program executed before the change processing (step S23) and the pre-processing of program to be executed after the change processing (step S24), in response to the instructions of post-processing and pre-processing transferred with the notification about the selected mode (see the steps S5 and S6 illustrated in FIG. 5).

Then, each of layers, i.e., the platform layer 101, the middleware layer 102 and the application layer 103 utilizes the scheduler 110 of own layer, and determines whether the predetermined time passes or not (step S25). When having determined that the predetermined time passes (S25: YES), each of layers performs the scheduling processing based on the predetermined algorism to change the program to be executed (step S26).

When the program has been changed or when each of layers has determined that the predetermined time does not pass (S25: NO), the scheduler 110 of each layer contributes to execute the current program of own layer (step S27), and determines whether the executed current program generates the event or not (step S28). When having determined that the executed current program generates the event (S28: YES), the scheduler 110 of each layer contributes to notify about the event occurrence to the system scheduler 143 of system manager layer 104 (step S29). When having determined that the executed current program does not generate the event (S28: NO), the scheduler 110 of each layer contributes to terminate the procedure without such notification.

Each of layers, i.e., the platform layer 101, the middleware layer 102 and the application layer 103 repeats the procedure from the step S21 to the step S28 described above. Therefore, it is possible to continuously perform the processing for changing the program to be executed, the scheduling processing about plural programs included in each layer, the notifying processing of event occurrence caused by the executed program, and the like. Although the flowchart of FIG. 7 is illustrated to change the program to be executed after the predetermined time passes, it may be configured to further change the program to be executed even after the event occurs.

In the on-vehicle device control program 100 as described above, the system monitoring program 141 of system manager layer 104 contributes to obtain the operation conditions of programs included in each layer, to determine whether the current mode should be changed or not, and to select a mode based on the obtained operation conditions in the case of determining that the current mode should be changed, and the system configuration managing program 142 contributes to notify about the selected mode to the configuration managing program 111 of each layer and to make each layer perform the post-processing and the pre-processing due to the change processing. Therefore, the configuration managing program 111 of each layer can determine in accordance with the notified selected mode whether each program should be executed or not, and can change the program configuration of each layer. It is enough for the scheduler 110 of each layer to execute only the program determined to be executed and to perform only the scheduling processing of program determined to be executed. Although each layer includes several programs, it is possible to limit programs to be executed in accordance with the selected mode, and then it is possible to simplify the dependence of programs. Therefore, a program developer for each layer can focus on the development of programs in each mode, and the development will be facilitated.

In the on-vehicle device control program 100, the system scheduler 143 contributes to change the current activated scheduler 110 of layer with another scheduler 110 of another layer and to perform the scheduling of such scheduler change, in accordance with the notification about the passage of predetermined time from the time managing program 144 and the notification about the event occurrence from the scheduler 110 of any layer, and the scheduler 110 of each layer contributes to change the program to be executed and to perform the scheduling processing of programs to be executed, in accordance with the time passage and/or the notification from any program. In other words, the on-vehicle device control program 100 is configured to be hierarchized and to functionally position the system scheduler 143 of system manager layer 104 higher than the scheduler 110 of each layer, for performing the scheduling processing. Thus, it is enough for a program developer of scheduler 110 included in each layer to consider only programs included in own layer, but not programs included in the other layers. Therefore, it is possible to facilitate developing.

As described above, the on-vehicle device control program 100 according to the present invention functionally positions the platform layer 101, the middleware layer 102 and the application layer 103 independently from each other not only for transmitting data but also for executing and scheduling programs. Therefore, it is possible to facilitate developing programs of each layer, to improve the facility for modifying each layer, and to improve the replaceability and the reusability of each layer.

The on-vehicle device control program 100 is illustrated in this embodiment to be hierarchized into three layers, i.e., the platform layer 101, the middleware layer 102 and the application layer 103. However, the present invention is not limited to this illustration. The on-vehicle device control program 100 may be hierarchized into two layers or not less than four layers. In addition, the on-vehicle device control program 100 is illustrated in this embodiment to be a computer program for controlling a device. However, the present invention is not limited to this illustration. The on-vehicle device control program 100 may be applied to another computer program for controlling other types of devices. Although FIG. 3 shows example programs included in the application layer 103, the present invention is not limited to these example programs. Although FIG. 4 shows example programs corresponding to four modes, the present invention is not limited to these example programs.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-9. (canceled)

10. A control apparatus that controls a connected device, comprising:
a controller for controlling the connected device, which is configured with plural control units; and
a control unit regulator that regulates the plural control units, wherein
each control unit comprises plural programs and a program regulating section that regulates the plural programs,
when regulated by the control unit regulator, each control unit makes own program regulating section select a program to be executed among own plural programs, and
each control unit executes own selected program to control the connected device.

11. A control apparatus according to claim 10, wherein
each control unit comprises:
a determining section that determines whether it is required for executing own selected program to execute a program of another control unit or not; and
a notifying section that notifies to the control unit regulator about determination results when the determining section determines that it is required to execute the program of another control unit, and
when notified by the notifying section, the control unit regulator makes said another control unit execute the program of another control unit.

12. A control unit according to claim 10, further comprising:
a setting unit that sets plural actuation modes utilized for the connected device, wherein
each control unit further comprises an actuation mode selecting section that selects an actuation mode among the plural actuation modes selected by the setting unit,
plural programs in each control unit are categorized into plural program groups based on the plural actuation mode set by the setting unit, and
the program regulating section in each control unit selects a program categorized into a program group corresponding to the actuation mode selected by own actuation mode selecting unit.

13. A control apparatus according to claim 12, wherein
each control unit comprises an initializing section and is initialized own operation by the initializing section when own actuation mode selecting section selects an actuation mode different from current actuation mode.

14. A control apparatus according to claim 12, wherein
the control apparatus is an electronic control unit mounted on a vehicle, and
the connected device is mounted on the vehicle.

15. A control apparatus according to claim 14, further comprising:
a detector that detects an operation condition of the vehicle, wherein
the control unit regulator notifies a result detected by the detector to the plural control units, and
the actuation mode selecting section of each control unit selects the actuation mode, in accordance with the notified result, among the plural actuation modes set by the setting unit.

16. A control apparatus according to claim 15, wherein
the plural control units are configured with a platform control unit, a middleware control unit and an application control unit,
the platform control unit performs data transmission between the connected device and the middleware control unit,
the middleware control unit performs data transmission between the platform control unit and the application control unit, and
the application control unit generates data representing an actuation instruction for the connected device in accordance with data received from the middleware control unit and transmits the generated data to the middleware control unit.

17. A control apparatus according to claim 16, wherein
each control unit comprises, as the plural program groups, a program group utilized for security of the vehicle and a program group utilized during a period when the vehicle is driven.

18. A control apparatus according to claim 16, wherein
the setting unit sets, as the plural actuation modes, a normal actuation mode, an energy saving actuation mode, and a factory shipping mode.

19. A control apparatus according to claim 16, wherein
the application control unit comprises, as the plural programs, a program regarding door lock of the vehicle, a program regarding a headlight of the vehicle, and a program regarding a wiper of the vehicle.

20. A non-transitory computer readable medium having stored thereon computer executable program for controlling a connected device, wherein
the computer program when executed causes a computer system to execute steps of:
preparing a controller for controlling the connected device;
configuring the prepared controller with plural control units;
preparing a control unit regulator that regulates the plural control units;
preparing, in each control unit, plural programs and a program regulating section that regulates the plural programs;
utilizing the program regulating section of control unit regulated by the control regulator to select a program to be executed among the plural programs of control unit regulated by the control unit regulator; and
making each control unit execute the program selected by own program regulating section to control the connected device.

21. A non-transitory computer readable medium according to claim 20, wherein
the computer program when executed causes the computer system to execute further steps of
preparing, in each control unit, a determining section that determines whether it is required for executing own selected program to execute a program of another control unit or not;
preparing, in each control unit, a notifying section that notifies to the control unit regulator about determination results when the determining section determines that it is required to execute the program of another control unit; and
utilizing the control unit regulator, when notified by the notifying section, to make said another control unit execute the program of another control unit.

22. A non-transitory computer readable medium according to claim 20, wherein
the computer program when executed causes the computer system to execute further steps of:
setting plural actuation modes utilized for controlling the connected device;
further preparing, in each control unit, an actuation mode selecting section that selects an actuation mode among the set plural actuation modes;
categorizing the plural programs of each control unit into plural program groups based on the set plural actuation modes; and
making the program regulating section of each control unit select a program categorized in the program group based on the actuation mode selected by own actuation mode selecting section.

23. A non-transitory computer readable medium according to claim 22, wherein
the computer program when executed causes the computer system to execute further a step of:
preparing, in each control unit, an initializing section; and
initializing an operation of each control unit with utilizing own initializing section when own actuation mode selecting section selects an actuation mode different from current actuation mode.

24. A non-transitory computer readable medium according to claim 22, wherein
the computer program is executed by an electronic control unit mounted on a vehicle, and
the connected device is mounted on the vehicle.

25. A non-transitory computer readable medium according to claim 24, wherein
the computer program when executed causes the computer system to execute further steps of:
detecting an actuation condition of the vehicle;
utilizing the control unit regulator to notify to the plural control units about a result of the detection; and
making the actuation mode selecting section of each control unit select the actuation mode, in accordance with a result of the notification, among the set plural actuation modes.

26. A non-transitory computer readable medium according to claim 25, wherein
the computer program when executed causes the computer system to execute further steps of:
configuring the plural control units with a platform control unit, a middleware control unit and an application control unit;
making the platform control unit perform data transmission between the connected device and the middleware control unit;
making the middleware control unit perform data transmission between the platform control unit and the application control unit; and
making the application control unit generate data representing an actuation instruction for the connected device in accordance with data received from the middleware control unit and transmit the generated data to the middleware control unit.

27. A non-transitory computer readable medium according to claim 26, wherein
the computer program when executed causes the computer system to execute further a step of:
configuring the plural program groups of each control unit with a program group utilized for security of the vehicle and a program group utilized during a period when the vehicle is driven.

28. A non-transitory computer readable medium according to claim 26, wherein
the computer program when executed causes the computer system to execute further a step of:
configuring the set plural actuation modes with a normal actuation mode, an energy saving actuation mode, and a factory shipping mode.

29. A non-transitory computer readable medium according to claim 26, wherein
the computer program when executed causes the computer system to execute further a step of:
configuring the plural program of application control unit with a program regarding door lock of the vehicle, a program regarding a headlight of the vehicle, and a program regarding a wiper of the vehicle.
